(19) United States
(12) Patent Application Publication
(10) Pub. No.: US 2024/0270986 A1
(43) Pub. Date: Aug. 15, 2024

(54) ELECTROPHORETIC COATING SOLUTION, ELECTROPHORETIC DISPLAY PANEL AND DISPLAY DEVICE

(71) Applicant: SHANGHAI TIANMA MICROELECTRONICS CO., LTD., Shanghai (CN)

(72) Inventors: Jian JIN, Shanghai (CN); Bin CHENG, Shanghai (CN)

(73) Assignee: SHANGHAI TIANMA MICROELECTRONICS CO., LTD., Shanghai (CN)

(21) Appl. No.: 18/646,806

(22) Filed: Apr. 26, 2024

(30) Foreign Application Priority Data
Jan. 19, 2024 (CN) 202410082845.3

(51) Int. Cl. C09D 5/44; C09C 3/08; C09D 7/20; C09D 7/40; G02F 1/167; G02F 1/16757

(52) U.S. Cl. CPC C09D 5/448; C09C 3/08; C09D 7/20; C09D 7/70; G02F 1/167; G02F 1/16757

(57) ABSTRACT

Provided is an electrophoretic coating solution, comprising 100 parts by weight of microcapsules modified with an olefinic aldehyde compound; 1 to 20 parts by weight of a resin monomer and/or an unsaturated resin; and 50 to 100 parts by weight of a solvent. Also provided are an electrophoretic display panel and a display device. In this solution, the electrophoretic coating solution has good dispersibility, and the yield of the electrophoretic display panel is improved.

This application claims the priority of Chinese Patent Application No. 202410082845.3, filed with the China National Intellectual Property Administration on Jan. 19, 2024, and titled with “ELECTROPHORETIC COATING SOLUTION, ELECTROPHORETIC DISPLAY PANEL AND DISPLAY DEVICE”, which is hereby incorporated by reference.

### FIELD

The disclosure relates to the field of electrophoretic display, and in particular relates to an electrophoretic coating solution, an electrophoretic display panel and a display device.

### BACKGROUND

Electrophoretic image display (EPID) is a phenomenon that colloidal dispersed particles swim under the action of electric field, and has advantages of high contrast, large viewing angle, high display brightness, low price, and easy realization of large-plane display and the like. EPID display has disadvantages of poor reliability, difficult control of threshold characteristics, especially the phenomenon such as agglomeration and precipitation of particles in dispersion system, so its life is short. In recent years, the Media Laboratory of Massachusetts Institute of Technology (MIT) put forward the concept of encapsulated electronic ink, that is, encapsulated electrophoretic display. Based on the principle of electrophoretic display, pigment particles and dark dye solution are innovatively wrapped in microcapsules, and electrophoretic display is realized in the microcapsules, thus inhibiting the shortcomings of agglomeration and deposition of electrophoretic colloidal particles in a range larger than the size of capsules, improving their stability and prolonging their service life. Electronic ink is an ink-like suspension, which can realize reversible, bistable and flexible display under the action of external electric field. It is a flexible display material and technology that integrates disciplines such as physics, chemistry, and electronics. It has advantages of good visibility, low power consumption, strong information loading ability, convenient carrying, low manufacturing cost and no electromagnetic radiation, and can fundamentally solve the shortcomings of the existing flat panel display technology.

### SUMMARY

In view of this, the problem to be solved by the present disclosure is to provide an electrophoretic coating solution with good dispersibility, an electrophoretic display panel and a display device.

In the present disclosure, provided is an electrophoretic coating solution, comprising:
100 parts by weight of microcapsules modified with an olefinic aldehyde compound;
1 to 20 parts by weight of a resin monomer and/or an unsaturated resin;
50 to 100 parts by weight of a solvent.

In the present disclosure, further provided is an electrophoretic display panel, comprising a transparent conductive substrate, an electrophoretic coating layer and a driving backplane arranged in sequence; the electrophoretic coating layer is formed by an electrophoretic coating solution;
wherein the electrophoretic coating solution comprises:
100 parts by weight of microcapsules modified with an olefinic aldehyde compound;
1 to 20 parts by weight of a resin monomer and/or an unsaturated resin; and
50 to 100 parts by weight of a solvent.

In the present disclosure, further provided is a display device, comprising an electrophoretic display panel;
wherein the electrophoretic display panel comprises a transparent conductive substrate, an electrophoretic coating layer and a driving backplane arranged in sequence; the electrophoretic coating layer is formed by an electrophoretic coating solution;
wherein the electrophoretic coating solution comprises:
100 parts by weight of microcapsules modified with an olefinic aldehyde compound;
1 to 20 parts by weight of a resin monomer and/or an unsaturated resin; and
50 to 100 parts by weight of a solvent.

### BRIEF DESCRIPTION OF DRAWINGS

FIG. 1 is a schematic structural diagram of an existing electrophoretic display panel;

FIG. 2 is a specific structural schematic diagram of the electrophoretic display panel provided according to the present disclosure;

FIG. 3 is a diagram showing a principle of the electrophoretic coating solution provided according to the present disclosure;

FIG. 4 is another specific structural schematic diagram of the electrophoretic display panel provided according to the present disclosure;

FIG. 5 is another schematic diagram of an electrophoretic coating solution provided according to the present disclosure.

### DETAILED DESCRIPTION

The embodiments of the present disclosure will be clearly and completely described below in conjunction with the embodiments of the present disclosure. The described embodiments are only a part of the embodiments of the present disclosure, rather than all the embodiments.

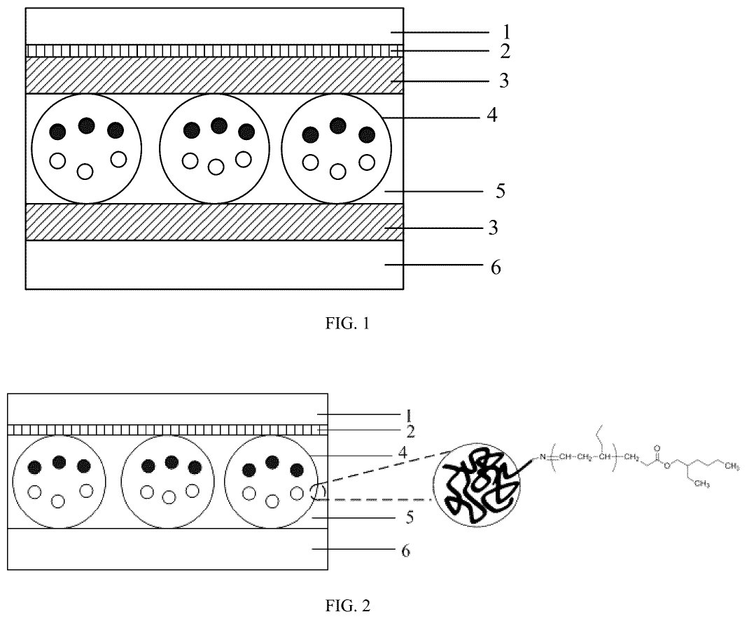

In current electronic ink, spherical transparent and smooth microcapsules of 100 microns to 2000 microns are used to coat a dielectric suspension, with charged electrophoretic particles floating in the suspension, and these capsules are distributed in a polyurethane adhesive to form a dispersed system, which is coated or printed on a flexible ITO conductive film to form a principle flexible EPID electronic paper, see FIG. 1 (in FIG. 1, 1 is a PET layer, 2 is an ITO layer, 3 is an adhesive layer, 4 is a microcapsule, 5 is an electrophoretic coating layer, and 6 is a backplane). The inventors found that the capsules could not be well dispersed in polyurethane adhesive, and there are shortcomings such as agglomeration of capsules in a large size range, resulting in difficulty in coating when conducting coating methods such as roller coating, screen printing, spraying, and the like, poor appearance of the coating film, and various appearance defects, including empty spots, scratches, protruding dots, bad spots and the like, and the yield is low. Moreover, the existing electrophoretic coating layer needs to be bonded to the backplane or transparent electrode by setting an adhesive layer with a thickness of about 100 μm to 250 μm due to its poor adhesion.

In order to solve the problems that the capsules are not easy to disperse in resin and the adhesion is poor, in the present disclosure, provided is an electrophoretic coating solution, comprising
100 parts by weight of microcapsules modified by an olefinic aldehyde compound;
1 to 20 parts by weight of a resin monomer and/or an unsaturated resin; and
50 to 100 parts by weight of a solvent.

The electrophoretic coating solution provided in the present disclosure contains an olefinic aldehyde compound, and a firm molecular structure is formed through aldehyde-amine condensation and addition reaction of two reactive sites of an aldehyde group and a double bond in the olefinic aldehyde compound with gelatin in the capsule wall of the microcapsule and resin monomer or unsaturated resin respectively, and the microcapsules are uniformly dispersed in the electrophoretic coating layer, and the dispersibility of the microcapsules in the electrophoretic coating layer is improved. In addition, the olefinic aldehyde compound bonds with the capsule wall of the microcapsule respectively, to enhance the bonding strength between the microcapsule and the adhesive, and avoiding the cracking of the coating layer caused by bending and folding or the like.

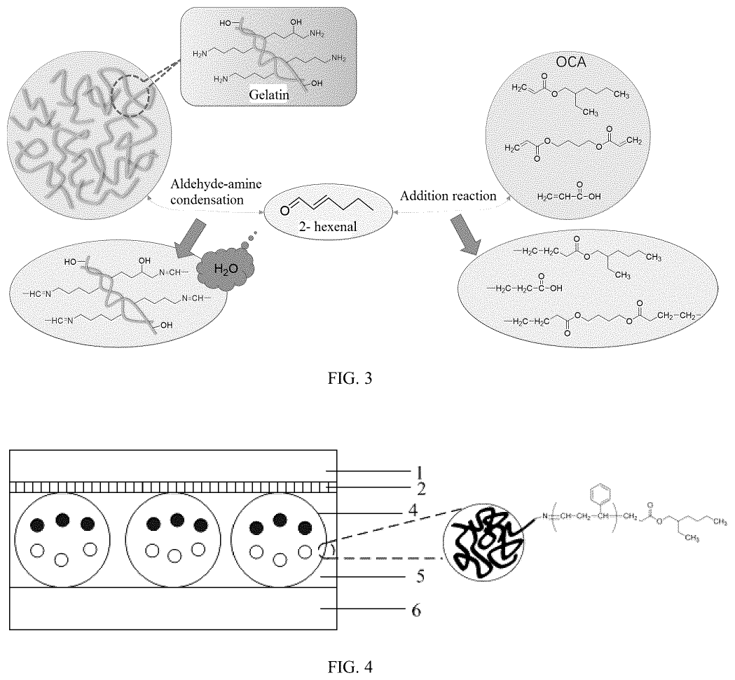

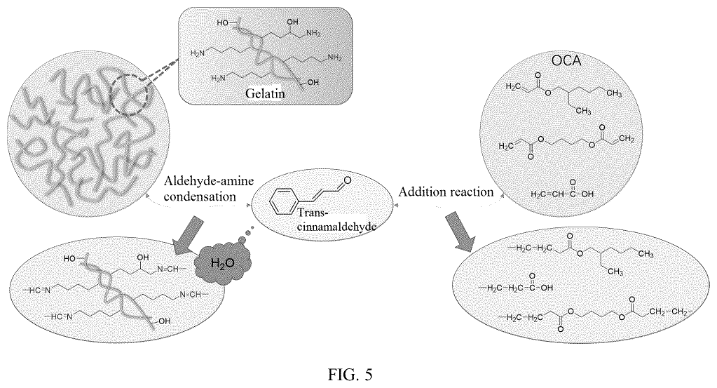

Referring to FIGS. 2 to 4, FIGS. 2 and 4 provide two specific structural schematic diagrams of electrophoretic display panel, in which 1 is a transparent substrate, 2 is a transparent electrode layer, 4 is a microcapsule, 5 is an electrophoretic coating layer, 6 is a driving backplane, and on the right side there is an enlarged schematic structure diagram of the capsule wall of the microcapsule; FIGS. 3 and 5 provide diagrams showing principles of the electrophoretic coating solution provided according to the present disclosure.

According to the present disclosure, microcapsules modified with an olefinic aldehyde compound are dispersed in the electrophoretic coating solution; the particle size of the microcapsule modified with an olefinic aldehyde compound can be specifically 30 μm to 300 μm, more specifically 30 μm to 200 μm, and further more specifically 30 μm to 100 μm. In the present disclosure, the microcapsules modified with an olefinic aldehyde compound refer to those formed by bonding the olefinic aldehyde compound to the capsule wall of the microcapsule through chemical bonds, and specifically by bonding the olefinic aldehyde compound to the capsule wall of the microcapsule through aldehyde-amine condensation.

In the present disclosure, the microcapsule modified with an olefinic aldehyde compound is specifically prepared by steps of: mixing microcapsules and an olefinic aldehyde compound in an organic solvent, adjusting a pH value of the reaction system to be alkaline, and heating for reaction to obtain the microcapsules modified with an olefinic aldehyde compound.

The capsule wall of the microcapsule comprises gelatin and a negatively charged polymer material; the mass ratio of the gelatin to the negatively charged polymer material can be specifically 1:1. The negatively charged polymer material is one well-known to those skilled in the art that can form a capsule wall with gelatin, and there is no special limitation. In the present disclosure, it is specifically natural vegetable gum and/or synthetic cellulose. More specifically, the natural vegetable gum can be one or more of Arabic gum, peach gum, pectin, apricot gum and alginic acid; the synthetic cellulose can be carboxymethyl cellulose; the capsule wall of the first microcapsule contains a suspension and multiple charged pigment particles dispersed in the suspension; the charged pigment particles can be inorganic particles and/or organic particles; the inorganic particles can be one or more of titanium dioxide, zinc white and cadmium yellow; the organic particles can be one or more of scarlet powder, toluidine red, titanium cyanine blue and pigment yellow; the solvent in the suspension is an organic solvent; the organic solvents can be epoxy compounds (such as epoxy decane), aromatic compounds (such as toluene and naphthalene), halogenated hydrocarbons (such as tetrachloroethylene) and their oligomers (such as polytrichloroethylene, with a polymerization degree of 2 to 10), wherein fluorine-containing (or perfluoro) organic solvents are more suitable as the solvent in the suspension due to their high density, good chemical stability and environmental friendliness. In the present disclosure, more specifically, the suspension also comprises a charge control agent; the charge control agent can be organic sulfate (calcium dodecyl benzene sulfonate, barium dinonylnaphthalene sulfonate, etc.), metal soap, organic amine, organic phosphate or phosphate ester, etc. In order to enhance the efficiency of the charge control agent, a certain amount of charge auxiliaries, such as polyhydroxy compounds or amino alcohol compounds can also be added.

The microcapsules are mixed with olefinic aldehyde compound in an organic solvent; the olefinic aldehyde compound is specifically represented as a formula (I):

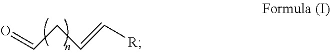

wherein n is an integer of 0 to 5, specifically 0, 1, 2 or 3; R is a substituted or unsubstituted C1 to C10 alkyl and a substituted or unsubstituted C6 to C20 aryl; the substituents in the substituted C1 to C10 alkyl and the substituted C6 to C20 aryl are each independently selected from the group consisting of C1 to C5 alkyl and C to C5 alkoxy and a combination thereof. Specifically, R is a substituted or unsubstituted C2 to C6 alkyl and a substituted or unsubstituted C6 to C10 aryl; the substituents in the substituted C2 to C6 alkyl and the substituted C6 to C10 aryl are each independently selected from the group consisting of C1 to C3 alkyl, C1 to C3 alkoxy and a combination thereof. More specifically, the olefinic aldehyde compound is selected from 2-hexenal and/or cinnamaldehyde. The olefinic aldehyde compound and microcapsules are mixed according to the proportion of the molar ratio of gelatin in the capsule walls of the microcapsules to olefinic aldehyde compound of 1:(0.8 to 1.5), more specifically 1:(1 to 1.2). The organic solvent is one well-known to those skilled in the art, and there is no special limitation. Specifically, it can be an alcohol solvent and/or dimethylformamide; and the alcohol solvent can be specifically ethanol. A duration of the mixing can be specifically 10 min to 90 min, more specifically 20 min, 30 min, 40 min, 50 min, 60 min, 70 min or 80 min.

After mixing, the pH value of the system is adjusted to be alkaline, and the system is heated for reaction. In the present disclosure, the pH value of the system can be specifically adjusted to 8 to 9. In the present disclosure, the pH value of the system can be adjusted by methods well known to those skilled in the art, and there is no special limitation. Specifically, alkali metal hydroxide can be added, more specifically, potassium hydroxide and/or sodium hydroxide can be added. The alkaline catalyst can be added in the form of its aqueous solution; the mass concentration of the aqueous alkali metal catalyst solution can be specifically 20% to 50%, more specifically 30%, 40% or 50%. A temperature of the heating can be 80° C. to 100° C.; a duration of the heating can be specifically 8 h to 15 h, more specifically 10 h to 12 h.

After the reaction, the organic solvent is removed to obtain the microcapsules modified with the olefinic aldehyde compound.

According to the disclosure, the electrophoretic coating solution contains a resin monomer and/or an unsaturated resin, and one end of the olefinic aldehyde compound reacts with gelatin in the capsule wall of the microcapsule, and the other end reacts with the double bond in the resin monomer and/or unsaturated resin to form a firm molecular structure, and the microcapsule is stably dispersed in the electrophoretic coating layer. The resin monomer and/or unsaturated resin is one well-known to those skilled in the art, and there is no special limitation. In the present disclosure, specifically, the resin monomer can be an acrylic monomer and/or an acrylate monomer. The acrylate monomer is selected from the group consisting of methyl acrylate, methyl methacrylate, tert-butyl acrylate, cyclohexyl methacrylate, ethyl methacrylate, n-butyl methacrylate, ethyl acrylate, n-propyl acrylate, n-butyl acrylate, isobutyl acrylate, tridecyl 2-methyl-2-acrylate and combinations thereof. The unsaturated resin can be selected from the group consisting of polyacrylic resin, polyacrylate resin, silicone resin, epoxy resin and combinations thereof, and more specifically, it can be selected from the group consisting of polyacrylic acid, polyacrylate, polyurethane, silicone-based resin, epoxy resin, poly(2-ethylhexyl acrylate), polyacrylic acid, polymethacrylic acid, polycloronic acid, poly(hydroxyethyl methacrylate), poly(hydroxypropyl methacrylate), poly(propylene glycol acrylate), polyacrylamide, polymethacrylamide, polyvinyl alcohol, poly(N-vinylpyrrolidone) and combinations thereof. The types of the resin monomer and/or unsaturated resin can also be selected according to the process requirements, for example, resin monomer and/or unsaturated resin with low viscosity can be selected for the needs of process simplicity and leveling, and UV curable resin monomer and/or unsaturated resin can be selected for avoiding the influence of thermal curing on devices. The number average molecular weight of the unsaturated resin can be specifically 500,000 to 1,200,000, more specifically 600,000 to 1,000,000, and more specifically 800,000 to 1,000,000. The polymerization degree of the unsaturated resin can be 7,000 to 17,000; the amount of the resin monomer and/or unsaturated resin in the electrophoretic coating solution can be specifically 5 to 20 parts by weight, and more specifically 8 to 15 parts by weight.

According to the disclosure, the electrophoretic coating solution may, in one embodiment, further includes an initiator; and the mass of the initiator is specifically 1% to 5% of the mass of the resin monomer and/or unsaturated resin. The initiator is preferably one or more of peroxide initiator, azo initiator and photoinitiator. The peroxide initiator is one well-known to those skilled in the art, and there is no special limitation. In the present disclosure, the peroxide initiator can be specifically one or more of potassium persulfate, sodium persulfate and ammonium persulfate. The azo initiator is one well-known to those skilled in the art, and there is no special limitation. In the present disclosure, the azo initiator can be specifically 2,2′-azobis(2-methylpropionitrile) and/or 2,2′-azobis(2,4-dimethyl)valeronitrile. The photoinitiator is a common UV photoinitiator, specifically, it can be selected from the group consisting of 2-hydroxy-methylphenylpropane-1-one, 1-hydroxycyclohexyl phenyl ketone, 2-methyl-1-(4-methylthiophenyl)-2-morpholinyl-1-propanone, benzoin dimethyl ether, 2,4,6 (trimethylbenzoyl)diphenylphosphine oxide, benzophenone, 2-isopropylthioxanthone, and combinations thereof.

In the present disclosure, the solvent is one well-known to those skilled in the art that can be used as a solvent of an electrophoretic coating solution, and there is no special limitation. It can be specifically one or more of water, alcohol solvents, ketone solvents, ester solvents and toluene. The alcohol solvent is one well-known to those skilled in the art, and there is no special limitation. In the present disclosure, it is specifically methanol and/or ethanol. The ketone solvent is one well-known to those skilled in the art, and there is no special limitation. In the present disclosure, it can be specifically one or more of ketone, acetone, butanone and methyl isobutyl ketone. The ester solvent is one well-known to those skilled in the art, and there is no special limitation. It can be specifically one or more of ethyl acetate, acetone ethyl acetate, butyl acetate and isobutyl acetate.

In the present disclosure, further provided is a method for preparing the electrophoretic coating solution, comprising steps of: mixing microcapsules modified with an olefinic aldehyde compound, a resin monomer and/or an unsaturated resin with a solvent, and heating for reaction to obtain the electrophoretic coating solution.

In the present disclosure, there is no special limitation on the sources of all raw materials, as long as they are commercially available. The types and amounts of the microcapsules modified with an olefinic aldehyde compound, the resin monomer and/or the unsaturated resin and the solvent are the same as stated above, and will not be repeated here.

The microcapsules modified with an olefinic aldehyde compound, the resin monomer and/or the unsaturated resin are mixed with the solvent; a rotational speed of the mixing can be specifically 100 rpm to 500 rpm, more preferably 200 rpm to 400 rpm; a duration of the mixing can be specifically 10 min to 90 min, more specifically 20 min, 30 min, 40 min, 50 min, 60 min, 70 min or 80 min.

After mixing, it can also be heated to obtain electrophoretic coating solution. The reaction of unsaturated bond on the outer wall of the microcapsule modified with an olefinic aldehyde compound with resin monomer and/or unsaturated resin is promoted by heating; a temperature of the heating is preferably 80° C. to 100° C.; a duration of the heating is preferably 0.5 h to 5 h, more preferably 1 h to 3 h.

In the present disclosure, further provided is an electrophoretic display panel, comprising a transparent conductive substrate, an electrophoretic coating layer and a driving backplane arranged in sequence; the electrophoretic coating layer is formed by the electrophoretic coating solution.

According to the present disclosure, the transparent conductive substrate comprises a transparent substrate and a transparent electrode layer; the transparent substrate can be made of materials such as polyethylene terephthalate (PET), polyethylene (PE), polyimide (PI), polyethylene naphthalate (PEN). The transparent conductive electrode can be specifically indium tin oxide (ITO) film, nano silver wire or graphene film.

An electrophoretic coating layer is arranged on the transparent electrode. A thickness of the electrophoretic coating layer is specifically 10 μm to 1000 μm, more specifically 50 μm to 800 μm, further more specifically 50 μm to 500 μm, further more specifically 50 μm to 300 μm, and further more specifically 50 μm to 200 μm.

A driving backplane is arranged on the electrophoretic coating layer. The driving backplane is one well-known to those skilled in the art, and there is no special limitation. Specifically, the driving backplane can be formed by manufacturing a thin film transistor driving circuit on a substrate such as glass, PI, PET and the like by a semiconductor process.

According to the present disclosure, more specifically, both the driving backplane and the transparent conductive substrate are connected with circuits for applying electrical signals on both sides of the electrophoretic coating layer. The driving electrode can be a pixel electrode of the electrophoretic display device, and the display of the electrophoretic coating layer is controlled by controlling a voltage signal on the driving electrode through a controller.

In another specific embodiment provided according to the present disclosure, a first coating layer is arranged between the transparent conductive substrate and the electrophoretic coating layer; the first coating layer is formed by a first coating solution; the first coating solution comprises 1 to 20 parts by weight of a resin monomer and/or an unsaturated resin; and 50 to 100 parts by weight of a solvent. The types of the resin monomer and/or unsaturated resin and solvent are the same as stated above and will not be repeated here. More specifically, the first coating solution has the same components as the electrophoretic coating solution except that it does not contain microcapsules. A thickness of the first coating layer can be 10 μm to 50 μm.

In another specific embodiment provided according to the present disclosure, a second coating layer is arranged between the electrophoretic coating layer and the driving backplane; the second coating layer comprises 1 to 20 parts by weight of a resin monomer and/or an unsaturated resin, and 50 to 100 parts by weight of a solvent. The types of the resin monomer and/or unsaturated resin and solvent are the same as stated above and will not be repeated here. The thickness of the second coating layer is 10 μm to 50 μm.

By arranging a microcapsule-free coating between the electrophoretic coating layer and the driving backplane and/or the transparent conductive substrate, the bonding force between the electrophoretic coating layer and the driving backplane and/or the transparent conductive substrate can be improved.

In the present disclosure, further provided is a method for preparing the electrophoretic display panel, comprising steps of: forming a film of the above-mentioned electrophoretic coating solution on a transparent conductive substrate, and then covering the driving backboard on the electrophoretic coating film and curing to obtain the electrophoretic display panel.

In the present disclosure, the film forming method is a method well known to those skilled in the art, and there is no special limitation. It can be selected according to the viscosity of the electrophoretic coating solution. For example, if the electrophoretic coating solution has a low viscosity, inkjet printing can be selected, and if the electrophoretic coating solution has a high viscosity, coating or screen printing can be selected.

In the present disclosure, the curing method is a method well known to those skilled in the art, and there is no special limitation. In order to avoid the influence of heat treatment on the flatness of the electrophoretic coating, light curing method is preferred, which can improve the flatness and yield of the electrophoretic coating layer.

In the present disclosure, further provided is a display device comprising the above-mentioned electrophoretic display panel.

In the present disclosure, the display device can be a mobile phone display screen, a computer display screen, a television display screen, a smart watch display screen, a smart car display screen, a VR or AR helmet display screen, a display screen of various intelligent devices, and the like.

Compared with the prior art, in the present disclosure, by adding an olefinic aldehyde compound to the electrophoretic coating solution, a firm molecular structure is formed through aldehyde-amine condensation and addition reaction of two reactive sites of an aldehyde group and a double bond in the olefinic aldehyde compound with gelatin in the capsule wall of the microcapsule and resin monomer or unsaturated resin respectively, and the microcapsules are uniformly dispersed in the electrophoretic coating layer and the dispersibility of the microcapsules in the electrophoretic coating layer is improved, to avoid the appearance defects such as empty spots, scratches, protruding dots, bad spots and the like appearing in the electrophoretic coating layer, and improving the yield of the electrophoretic display panels. In addition, the olefinic aldehyde compound bonds with the capsule wall of the microcapsule respectively, to enhance the bonding strength between the microcapsule and the adhesive, and avoiding the cracking of the coating layer caused by bending and folding or the like.

Furthermore, in the present disclosure, an acrylic monomer, an acrylate monomer, polypropylene, modified polypropylene, polypropylene ester and modified polypropylene ester are used as adhesive substances, which improve the optical performance of the electrophoretic coating layer.

Furthermore, in the present disclosure, ultraviolet curable resins are used, which improves the flatness and yield of the electrophoretic coating layer.

The embodiments will be clearly and completely described below in conjunction with the examples of the present disclosure. The described examples are only a part of the examples of the present disclosure, rather than all the examples.

The hydrolysis degree of gelatin used in the examples is 5% at room temperature, which can be improved by heating, and can be completely hydrolyzed at 60° C., reaching 100%. The molecular weight of polypropylene used in the examples is 800,000 to 1,000,000; the molecular weight of the used polymethacrylic acid is 800,000 to 1,000,000.

### Example 1

1.1 5 g of gelatin was added to 100 mL of deionized water and dissolved with stirring at a dissolution temperature of 42° C. At the same time, 5 g Arabic gum and 100 mL deionized water were dissolved with stirring at a dissolution temperature of 40° C. After the gelatin was completely dissolved, an electrophoretic display solution was added, and the mixture was stirred and dispersed with an adjusted rotational speed for 45 min. Then the completely dissolved Arabic gum solution was added, and the mixture was continued to be stirred and dispersed with an adjusted appropriate rotational speed for 30 min. Then the mixture was adjusted to a pH of 4.5 with acetic acid aqueous solution having a mass fraction of 10%, and stirred and dispersed with an adjusted appropriate rotational speed for another 30 min. The temperature was lowered to 10° C. for 3 h. A glutaraldehyde solution with a mass fraction of 50% was added. Cross-linking and curing reaction of microcapsules was performed for 10 h with an increased reaction temperature of 25° C. Microcapsules were collected. Microcapsules with particle size of 50 μm to 80 μm were selected by vibrating screen method with microporous filter screen.

1.2 The microcapsules obtained in 1.1 and 2-hexenal were mixed in ethanol according to a molar ratio of gelatin to 2-hexenal of 1:1 for 1 h. After fully dissolving, an aqueous sodium hydroxide solution was added to make the pH value of the reaction system 8 to 9. The system was warmed up to 100° C. and reacted for 12 h, and solvent was removed, to obtain microcapsules modified with 2-hexenal.

1.3 Formula of the electrophoretic coating solution:
100 parts by weight of microcapsules modified with 2-hexenal;
1 part by weight of polyacrylic acid;
50 parts by weight of ethyl acetate;
0.01 part by weight of 1-hydroxycyclohexyl phenyl ketone;

The microcapsules modified with 2-hexenal, polyacrylic acid, 1-hydroxycyclohexyl phenyl ketone were mixed with ethyl acetate and heated to 80° C. to react for 1 h to obtain an electrophoretic coating solution.

1.4 The electrophoretic coating solution was coated on an ITO conductive glass with a coating thickness of 50 μm, a TFT-driven backplane was placed on the coating layer, and UV curing was carried out to obtain an electrophoretic display.

### Example 2

Formula of electrophoretic coating solution:
100 parts by weight of microcapsules modified with 2-hexenal;
20 parts by weight of polyacrylic acid;
100 parts by weight of ethyl acetate;
0.2 part by weight of 1-hydroxycyclohexyl phenyl ketone.

The microcapsules modified with 2-hexenal were those prepared in Example 1, and the preparation methods of electrophoretic coating solution and electrophoretic display were the same as in Example 1.

### Example 3

Formula of electrophoretic coating solution:
100 parts by weight of microcapsules modified with 2-hexenal;
10 parts by weight of methyl acrylate;
80 parts by weight of ethyl acetate;
0.2 part by weight of 1-hydroxycyclohexyl phenyl ketone;
0.3 parts by weight of ammonium persulfate.

The microcapsules modified with 2-hexenal were those prepared in Example 1, and electrophoretic coating solution and the preparation methods of the electrophoretic display were the same as in Example 1.

### Example 4

4.1 5 g of gelatin was added to 100 mL of deionized water and dissolved with stirring at a dissolution temperature of 42° C. At the same time, 5 g Arabic gum and 100 mL deionized water were dissolved with stirring at a dissolution temperature of 40° C. After the gelatin was completely dissolved, an electrophoretic display solution was added, and the mixture was stirred and dispersed with an adjusted rotational speed for 45 min. Then the completely dissolved Arabic gum solution was added, and the mixture was continued to be stirred and dispersed with an adjusted appropriate rotational speed for 30 min. Then the mixture was adjusted to a pH of 4.5 with acetic acid aqueous solution having a mass fraction of 10%, and stirred and dispersed with an adjusted appropriate rotational speed for another 30 min. The temperature was lowered to 10° C. for 3 h. A glutaraldehyde solution with a mass fraction of 50% was added. Cross-linking and curing reaction of the microcapsules was performed for 10 h with an increased reaction temperature of 25° C. Microcapsules were collected. Microcapsules with particle size of 50 μm to 80 μm were selected by vibrating screen method with microporous filter screen.

4.2 The microcapsules obtained in 4.1 and trans-cinnamaldehyde were mixed in ethanol according to a molar ratio of gelatin to trans-cinnamaldehyde of 1:1 for 1 h. After fully dissolving, an aqueous sodium hydroxide solution was added to make the pH value of the reaction system 8 to 9. The system was warmed up to 100° C. and reacted for 12 h, and the solvent was removed, to obtain microcapsules modified with cinnamaldehyde.

4.3 Formula of electrophoretic coating solution:
100 parts by weight of microcapsules modified with cinnamaldehyde;
1 part by weight of polymethacrylic acid;
50 parts by weight of ethyl acetate;
0.01 part by weight of 1-hydroxycyclohexyl phenyl ketone;

The microcapsules modified with cinnamaldehyde, polymethacrylic acid, 1-hydroxycyclohexyl phenyl ketone were mixed with ethyl acetate and heated to 80° C. to react for 1 h to obtain an electrophoretic coating solution.

4.4 The electrophoretic coating solution was coated on ITO conductive glass with a coating thickness of 50 μm, a TFT-driven backplane was placed on the coating layer, and UV curing was carried out to obtain an electrophoretic display.

### Example 5

Formula of electrophoretic coating solution:
100 parts by weight of microcapsules modified with cinnamaldehyde;
15 parts by weight of cyclohexyl methacrylate;
100 parts by weight of ethyl acetate;
0.2 part by weight of 1-hydroxycyclohexyl phenyl ketone;
0.45 part by weight of ammonium persulfate.

The microcapsules modified with cinnamaldehyde were those prepared in Example 4, and the preparation methods of electrophoretic coating solution and electrophoretic display were the same as in Example 4.

### Example 6

Formula of electrophoretic coating solution:
100 parts by weight of microcapsules modified with cinnamaldehyde;
10 parts by weight of methyl acrylate;
80 parts by weight of ethyl acetate;
0.2 part by weight of 1-hydroxycyclohexyl phenyl ketone;
0.3 parts by weight of ammonium persulfate.

The microcapsules modified with cinnamaldehyde were those prepared in Example 4, and the preparation methods of electrophoretic coating solution and electrophoretic display were the same as in Example 4.

### Example 7

The electrophoretic coating solution was the same as in Example 3. The first coating solution and the second coating solution had the same composition as the electrophoretic coating solution, except that they did not contain microcapsules.

The first coating solution was coated onto the ITO conductive glass with a coating thickness of 10 μm. After UV curing, an electrophoretic coating solution was coated with a coating thickness of 50 μm. After UV curing, a second coating solution was coated with a coating thickness of 10 μm. A TFT driver backplane was placed on the coating layer, and UV curing was carried out to obtain an electrophoretic display.

### Comparative Example 1

The formula of electrophoretic coating solution was the same as that of Example 1, except that the microcapsules obtained in 1.1 in Example 1 were added.

The preparation method of the electrophoretic display was the same as that of Example 1.

### Comparative Example 2

The formula of electrophoretic coating solution was the same as that of Example 2, except that the microcapsules obtained in 1.1 in Example 1 were added.

The preparation method of electrophoretic display was the same as that of Example 1.

The electrophoretic displays of Examples 1 to 6 and Comparative Examples 1 to 2 were subjected to T-peel test, and their average values were taken. As shown in the results in Table 1, the electrophoretic coating solution provided by the present disclosure can reach the peeling strength equivalent to that of the comparative example after using less adhesive and tackifying resin. When the amount of colloid is equal, the example has more advantages in peel strength. In comparative example, when forming the electrophoretic coating layer, as the strength of the microcapsules is weak and it is easier to cause cohesive damage in the electrophoretic coating layer. In contrast, the electrophoretic coating layer made by the method of this application has stronger cohesion, and is therefore significantly less affected by external forces.

TABLE 1
Results of the T-peel test of the electrophoretic display

| | Comparative | Comparative | | | | | | |
|---|---|---|---|---|---|---|---|---|
| | example 1 | example 2 | Example 1 | Example 2 | Example 3 | Example 4 | Example 5 | Example 6 |
| Peel | 595 | 610 | 640 | 680 | 665 | 620 | 640 | 636 |
| strength | | | | | | | | |
| (gf/2.5 cm) | | | | | | | | |
| Remarks | The | The | The | The | The | The | The | The |
| | cohesion of | cohesion of | cohesion of | cohesion of | cohesion of | cohesion of | cohesion of | cohesion of |
| | electrophoretic | electrophoretic | electrophoretic | electrophoretic | electrophoretic | electrophoretic | electrophoretic | electrophoretic |
| | coating layer | coating layer | retic coating | retic coating | retic coating | retic coating | retic coating | retic coating |
| | is obviously | is obviously | layer is slightly | layer is slightly | layer is slightly | layer is | layer is | layer is |
| | damaged, and | damaged, and | damaged, and | damaged, and | damaged, and | damaged, and | damaged, and | damaged, and |
| | trace amounts | trace amounts | more capsules | more capsules | more capsules | more capsules | more capsules | more capsules |
| | of capsules | of capsules | and colloids | and colloids | and colloids | and colloids | and colloids | and colloids |
| | and colloids | and colloids | adhere to | adhere to | adhere to | adhere to | adhere to | adhere to |
| | adhere to | adhere to | the side of | the side of | the side of | the side of | the side of | the side of |
| | the side of | the side of | the ITO film. | the ITO film. | the ITO film. | the ITO film. | the ITO film. | the ITO film. |
| | the ITO film. | the ITO film. | | | | | | |

### Coating Yield:

The appearance of electrophoretic displays was analyzed to obtain the coating yield. The analysis results are shown in Table 2. The analysis samples are the electrophoretic displays prepared in Examples 1 to 6 and Comparative Examples 1 to 2. The results show that the test samples of Examples 1 to 6 have excellent appearance, and no appearance defects such as bad spots, shrinkage cavities, black spots and empty spots are found. In contrast, the samples of Comparative Examples 1 to 2 show obvious bad spots, shrinkage cavities and black spots gathering, and even horizontal stripes, which affect the coating yield and increase the loss. It shows that the embodiments can effectively reduce the agglomeration and uneven dispersion of the capsules, and is more conducive to the tight arrangement of the capsules and reducing gaps, thereby being conducive to the improvement of photoelectric performance and membrane utilization.

TABLE 2
Analysis Results of Coating Yield

| | Condition of | | |
|---|---|---|---|
| | shrinkage | Condition of | Coating |
| | cavities | bad dots | Yield |
| Example 1 | no | no | excellent |
| Example 2 | no | no | excellent |
| Example 3 | no | no | excellent |
| Example 4 | no | no | excellent |
| Example 5 | no | no | excellent |
| Example 6 | no | no | excellent |
| Comparative | Presence of | Presence of | poor |
| example 1 | shrinkage | bad dots and | |
| | cavities | black dots | |
| | | gathering | |
| Comparative | Presence of | Presence of | poor |
| example 2 | shrinkage | bad dots and | |
| | cavities | black dots | |
| | | gathering | |

### Bending Performance Test:

The bending properties of the electrophoretic displays obtained in Examples 1 to 6 were tested, and the results showed that the bending radius was ≤2 mm, the bending angle was 0° to 180°, and the bending times were >200,000 times.

The above examples are introduced only to aid in understanding of the method and core concept of the present disclosure. It should be noted that, for those skilled in the art, many improvements and modifications may be further made to the present disclosure without departing from the principle of the present disclosure, and these improvements and modifications also fall within the protection scope of claims of the present disclosure.

1. An electrophoretic coating solution, comprising:
100 parts by weight of microcapsules modified with an olefinic aldehyde compound;
1 to 20 parts by weight of a resin monomer and/or an unsaturated resin; and
50 to 100 parts by weight of a solvent.

2. The electrophoretic coating solution according to claim 1, wherein the microcapsules modified with an olefinic aldehyde compound are prepared by steps of:
mixing microcapsules and an olefinic aldehyde compound in an organic solvent, adjusting a pH value of the reaction system to be alkaline, and heating for reaction to obtain the microcapsules modified with an olefinic aldehyde compound;
wherein capsule walls of the microcapsules comprise gelatin and a negatively charged polymer material.

3. The electrophoretic coating solution according to claim 2, wherein the olefinic aldehyde compound is represented as formula (I): 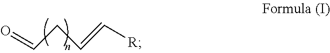
wherein, n is an integer of 0 to 5;
R is a substituted or unsubstituted C1 to C10 alkyl and a substituted or unsubstituted C6 to C20 aryl;
substituents in the substituted C1 to C10 alkyl and the substituted C6 to C20 aryl are each independently selected from the group consisting of C1 to C5 alkyl, C1 to C5 alkoxy and a combination thereof.

4. The electrophoretic coating solution according to claim 3, wherein n is 0, 1, 2 or 3.

5. The electrophoretic coating solution according to claim 3, wherein R is a substituted or unsubstituted C2 to C6 alkyl and a substituted or unsubstituted C6 to C10 aryl;
the substituents in the substituted C2 to C6 alkyl and the substituted C6 to C10 aryl are each independently selected from the group consisting of C1 to C3 alkyl, C1 to C3 alkoxy and a combination thereof.

6. The electrophoretic coating solution according to claim 3, wherein the olefinic aldehyde compound is selected from 2-hexenal and/or cinnamaldehyde.

7. The electrophoretic coating solution according to claim 2, wherein the organic solvent is selected from an alcohol solvent and/or dimethylformamide;
and/or, the pH value of the reaction system is adjusted to 8 to 9;
and/or, a temperature of the heating for reaction is 80° C. to 100° C.;
and/or, a duration of the heating for reaction is 8 h to 15 h.

8. The electrophoretic coating solution according to claim 2, wherein a mass ratio of the gelatin to the negatively charged polymer material in the capsule walls of the microcapsules is 1:1;
a molar ratio of the gelatin to the olefinic aldehyde compound in the capsule walls of the microcapsules is 1:(0.8 to 1.5).

9. The electrophoretic coating solution according to claim 2, wherein the negatively charged polymer material is selected from a natural vegetable gum and/or a synthetic cellulose;
the natural plant gum is selected from the group consisting of Arabic gum, peach gum, pectin, apricot gum, alginic acid and a combination thereof;
the synthetic cellulose is selected from carboxymethyl cellulose.

10. The electrophoretic coating solution according to claim 2, wherein the resin monomer is selected from an acrylic monomer and/or an acrylate monomer;
the unsaturated resin is selected from the group consisting of polyacrylic acid, polyacrylate, polyurethane, silicone-based resin, epoxy resin, poly(2-ethylhexyl acrylate), polyacrylic acid, polymethacrylic acid, polycloronic acid, poly(hydroxyethyl methacrylate), poly(hydroxypropyl methacrylate), poly(propylene glycol acrylate), polyacrylamide, polymethacrylamide, polyvinyl alcohol, poly(N-vinylpyrrolidone) and a combination thereof.

11. The electrophoretic coating solution according to claim 1, wherein the electrophoretic coating solution further comprises an initiator; a mass of the initiator is 1% to 5% of a mass of the resin monomer and/or unsaturated resin.

12. The electrophoretic coating solution according to claim 1, wherein the solvent is selected from the group consisting of water, an alcohol solvent, a ketone solvent, an ester solvent, toluene and a combination thereof.

13. A method for preparing the electrophoretic coating solution according to claim 1, comprising:
mixing microcapsules modified with an olefinic aldehyde compound, a resin monomer and/or an unsaturated resin with a solvent, and heating for reaction to obtain the electrophoretic coating solution.

14. The method according to claim 13, wherein a temperature of the heating for reaction is 80° C. to 100° C.; a duration of the heating for reaction is 0.5 h to 5 h.

15. An electrophoretic display panel, comprising a transparent conductive substrate, an electrophoretic coating layer and a driving backplane arranged in sequence; the electrophoretic coating layer is formed by an electrophoretic coating solution;
wherein the electrophoretic coating solution comprises:
100 parts by weight of microcapsules modified with an olefinic aldehyde compound;
1 to 20 parts by weight of a resin monomer and/or an unsaturated resin; and
50 to 100 parts by weight of a solvent.

16. The electrophoretic display panel according to claim 15, wherein the electrophoretic coating layer has a thickness of 10 μm to 1000 μm.

17. The electrophoretic display panel according to claim 15, wherein a first coating layer is arranged between the transparent conductive substrate and the electrophoretic coating layer; the first coating layer is formed by a first coating solution;
the first coating solution comprises:
1 to 20 parts by weight of a resin monomer and/or an unsaturated resin;
50 to 100 parts by weight of a solvent;
and/or a second coating layer is arranged between the electrophoretic coating layer and the driving backplane; the second coating layer is formed by a second coating solution;
the second coating solution comprises:
1 to 20 parts by weight of a resin monomer and/or an unsaturated resin;
50 to 100 parts by weight of a solvent.

18. The electrophoretic display panel according to claim 17, wherein the first coating layer has a thickness of 10 μm to 50 μm;
and/or,
the second coating layer has a thickness of 10 μm to 50 μm.

19. A display device comprising an electrophoretic display panel;
wherein the electrophoretic display panel comprises a transparent conductive substrate, an electrophoretic coating layer and a driving backplane arranged in sequence; the electrophoretic coating layer is formed by an electrophoretic coating solution;
wherein the electrophoretic coating solution comprises:
100 parts by weight of microcapsules modified with an olefinic aldehyde compound;
1 to 20 parts by weight of a resin monomer and/or an unsaturated resin; and
50 to 100 parts by weight of a solvent.
